(19) United States
(12) Patent Application Publication
(10) Pub. No.: US 2022/0317845 A1
(43) Pub. Date: Oct. 6, 2022

(54) TOUCH PANEL DEVICE

(71) Applicant: KYOCERA Document Solutions Inc., Osaka-shi (JP)

(72) Inventor: Michiko TASHIRO, Osaka-shi (JP)

(21) Appl. No.: 17/708,065

(22) Filed: Mar. 30, 2022

(30) Foreign Application Priority Data
Mar. 31, 2021 (JP) 2021-061303

(51) Int. Cl. G06F 3/0488; G06F 3/041

(52) U.S. Cl. CPC G06F 3/0488; G06F 3/0412; G06F 3/0414; G06F 3/04186

(57) ABSTRACT

A touch panel device is provided with a display panel, a touch sensor, a panel driving unit, a division range setting unit, and a correction unit. The division range setting unit divides and sets the detection range of the touch sensor into a plurality of ranges. The correction unit corrects an object detection area for detecting a touch operation to an object in a touch sensor for each of a plurality of ranges based on operation position deviation data indicating an operation position deviation between a position where the object is displayed on the display panel and a touch operation position of the touch sensor for each of the plurality of ranges.

### INCORPORATION BY REFERENCE

This application is based upon and claims the benefit of priority from the corresponding Japanese Patent Application No. 2021-061303 filed on Mar. 31, 2021, the entire contents of which are incorporated herein by reference.

### BACKGROUND

The present disclosure relates to a touch panel device.

In recent years, touch panels have been mounted on a variety of display devices. For example, the touch panel is suitably mounted on a smartphone, a tablet terminal, and a portable game device. The touch panel typically includes a capacitive touch sensor disposed on a display panel for multiple inspection. An operator of the touch panel can operate the display panel by touching an object displayed on the display panel on the touch panel.

However, even if the operator intends to touch the object displayed on the display panel, the display panel may not operate as intended by the operator. For this reason, it has been studied to obtain the operating position of the operator on the touch panel with high accuracy. The input device determines the position of the fingertip of the user approaching the operation screen based on the detection results of both the proximity sensor and the touch panel, thereby reducing malfunction.

### SUMMARY

A touch panel device includes a display panel, a touch sensor, a panel driving unit, a division range setting unit, and a correction unit. The display panel displays a display image including an object on a display screen. The touch sensor detects a touch operation position touch operated within a detection range with respect to the display screen of the display panel. The panel driving unit drives the display panel in accordance with the touch operation position detected by the touch sensor. The division range setting unit divides and sets the detection range of the touch sensor into a plurality of ranges. The correction unit corrects an object detection area for detecting a touch operation on the object in the touch sensor for each of the plurality of ranges based on operation position deviation data showing an operation position deviation between a position where the object is displayed on the display panel and the touch operation position of the touch sensor for each of the plurality of ranges.

### BRIEF DESCRIPTION OF THE DRAWINGS

FIG. 1 is a block diagram of a touch panel device according to this embodiment.

FIG. 2A is a schematic perspective view of the touch panel device showing a positional relationship between an object of a display panel and an object detection area before correction of the touch sensor.

FIG. 2B is a schematic diagram of the touch panel device showing a positional relationship between an object of the display panel and an object detection area before correction of the touch sensor.

FIG. 2C is a schematic perspective view of the touch panel device showing a positional relationship between an object of the display panel and an object detection area after correction of the touch sensor.

FIG. 2D is a schematic diagram of the touch panel device showing a positional relationship between an object of the display panel and an object detection area after correction of the touch sensor.

FIG. 3A is a schematic view showing an object detection area before correction of the touch sensor.

FIG. 3B is a schematic view of a divided object detection area of the touch sensor.

FIG. 3C is a schematic diagram showing the result of touch operation performed on the object detection area.

FIG. 3D is a schematic view showing an object detection area after correction of the touch sensor.

FIG. 4 is a flowchart for acquiring operation position deviation data for correcting the object detection area in the touch panel device of the present embodiment.

FIG. 5 is a flowchart showing the operation of the touch panel device of the present embodiment.

FIG. 6A is a schematic view of the touch panel device of the present embodiment in which the mode of dividing the detection range is different.

FIG. 6B is a schematic view of the touch panel device of the present embodiment in which the mode of dividing the detection range is different.

FIG. 6C is a schematic view of the touch panel device of the present embodiment in which the mode of dividing the detection range is different.

FIG. 7 is a schematic view of an image forming apparatus including the touch panel device of this embodiment.

### DETAILED DESCRIPTION

Embodiments of the touch panel device according to the present disclosure will be described below with reference to the drawings. In the drawings, the same reference numerals are attached to the same or corresponding parts, and the description thereof will not be repeated.

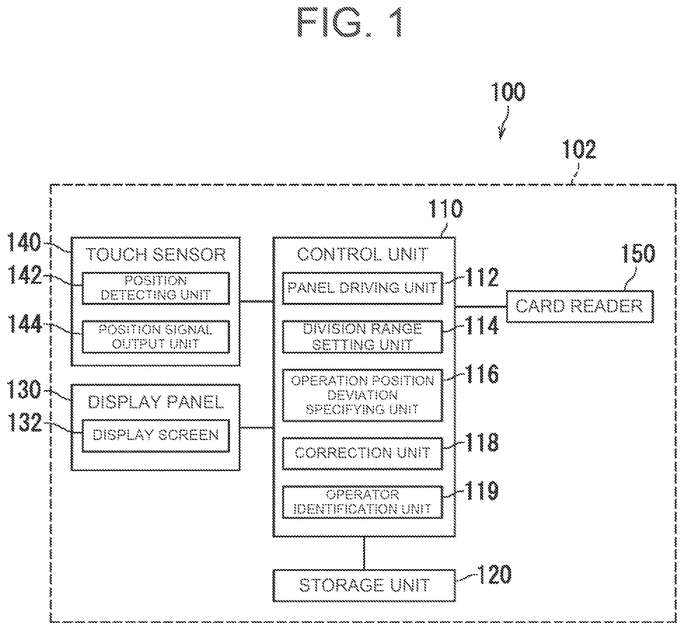

Referring to FIG. 1, the touch panel device 100 of the present embodiment will be described. FIG. 1 is a schematic block diagram of the touch panel device 100.

As shown in FIG. 1, the touch panel device 100 includes a control unit 110, a storage unit 120, a display panel 130, and a touch sensor 140. The control unit 110 controls the storage unit 120, the display panel 130, and the touch sensor 140.

Typically, the touch panel device 100 includes a housing 102. The housing 102 has a hollow box shape. The housing 102 houses the control unit 110, the storage unit 120, the display panel 130, and the touch sensor 140.

The control unit 110 includes an arithmetic element. The arithmetic element includes a processor. In one example, the processor includes a central processing unit (CPU).

The storage unit 120 stores data and a computer program. The storage unit 120 includes a storage element. The storage unit 120 includes a main storage element, such as a semiconductor memory, and an auxiliary storage element, such as a semiconductor memory and/or a hard disk drive. The storage unit 120 may include removable media. The processor of the control unit 110 executes a computer program stored in the storage element of the storage unit 120 to control each configuration of the touch panel device 100.

For example, a computer program is stored in a non-temporary computer readable storage medium. Non-temporary computer readable storage media include Read Only Memory (ROM), Random Access Memory (RAM), CD-ROM, magnetic tape, magnetic disk or optical data storage devices.

The display panel 130 has a display screen 132. The display panel 130 displays a display image including an object Ob on a display screen 132. The display image is displayed on the display screen 132. The display image including an object Ob is displayed on a display screen 132. For example, object Ob includes an icon, button, or software keyboard. Typically, the object Ob is superimposed on the background. However, a plurality of objects Ob may be superposed on the display screen 132.

The touch sensor 140 detects the touch operation of the operator. The touch sensor 140 is superposed on the display panel 130. At least a portion of the touch sensor 140 overlapping the display panel 130 is transparent. When an operator performs a touch operation on an object Ob displayed on the display panel 130, a touch sensor 140 detects a position where the operator performs the touch operation and outputs a detection result to a control unit 110.

The touch sensor 140 has a plurality of touch operation detection points. Typically, a plurality of touch operation detection points are arranged in a matrix of a plurality of rows and a plurality of columns. When any one of a plurality of touch operation detection points is touched, a touch sensor 140 specifies a touch operated point among the plurality of touch operation detection points.

For example, the touch sensor 140 is of a capacitance type. In this case, the touch sensor 140 can detect a plurality of touch operation positions without touching the operator's finger. However, the touch sensor 140 may be a contact type.

The touch sensor 140 has a position detecting unit 142 and a position signal output unit 144. The position detecting unit 142 detects a touch operation position of an operator. The position detecting unit 142 detects a touch operation position touch operated within a detection range with respect to a display screen 132 of the display panel 130. The position signal output unit 144 outputs the touch operation position signal indicating the touch operation position detected by the position detecting unit 142 to the control unit 110.

Upon execution of the computer program, the control unit 110 functions as a panel driving unit 112, a division range setting unit 114, the operation position deviation specifying unit 116, and a correction unit 118.

The panel driving unit 112 drives the display panel 130. The panel driving unit 112 drives the display panel 130 according to the touch operation position touched on the touch sensor 140. Specifically, the panel driving unit 112 drives the display panel 130 according to the touch operation position detected by the position detecting unit 142. Upon receiving the touch operation position signal output from the position signal output unit 144, the panel driving unit 112 drives the display panel 130 based on the touch operation position signal.

The division range setting unit 114 divides and sets the detection range DR of the touch sensor 140 into a plurality of ranges. For example, the division range setting unit 114 divides and sets the detection range DR of the touch sensor 140 into a plurality of ranges in the lateral direction (right-left direction). Alternatively, the division range setting unit 114 divides and sets the detection range DR of the touch sensor 140 into a plurality of ranges in the longitudinal direction (vertical direction). Alternatively, the division range setting unit 114 may divide and set the detection range DR of the touch sensor 140 into a plurality of ranges in the lateral direction (right-left direction) and the longitudinal direction (vertical direction), respectively.

An operation position deviation specifying unit 116 generates operation position deviation data showing an operation position deviation between a position where an object Ob is displayed on the display panel 130 and a touch operation position of a touch sensor 140 for each of a plurality of ranges. The operation position deviation data may be stored in the storage unit 120. Alternatively, the operation position deviation data may be acquired by another touch panel device 100 and stored in the storage unit 120.

An operation position deviation specifying unit 116 detects an operation position deviation between a position where an object is displayed on the display panel 130 and a touch operation position of a touch sensor 140 for each of a plurality of ranges. For example, the operation position deviation specifying unit 116 detects an operation position deviation between the center of the object and the touch operation position of the touch sensor 140 for each of a plurality of ranges.

The operation position deviation specifying unit 116 specifies the operation position deviation based on the touch operation position of each of a plurality of areas obtained by dividing the object detection area Od corresponding to the object Ob in the detection range.

The correction unit 118 corrects an object detection area Od for detecting a touch operation to the object Ob based on the operation position deviation data. The correction unit 118 corrects the position of the object detection area Od based on the operation position deviation data showing the deviation of the operation position stored in the storage unit 120. The correction unit 118 corrects an object detection area Od for each of a plurality of ranges based on the result detected by the operation position deviation specifying unit 116. The panel driving unit 112 drives the display panel 130 based on the touch operation position touched on the touch sensor 140 and the corrected object detection area Oc.

The touch panel device 100 may further include a card reader 150 for reading the ID card of the operator. For example, the card reader 150 is installed in the housing 102. Upon execution of the computer program, the control unit 110 functions as the operator identification unit 119. An operator identification unit 119 identifies an operator. For example, the touch panel device 100 may be logged in and enabled when the card reader 150 reads the ID card of the operator to identify the operator. In this case, the storage unit 120 may separately store the operation position deviation for each range obtained by dividing the detection range for each operator, and the correction unit 118 may correct the object detection area Od based on the detection operation position deviation data for each operator.

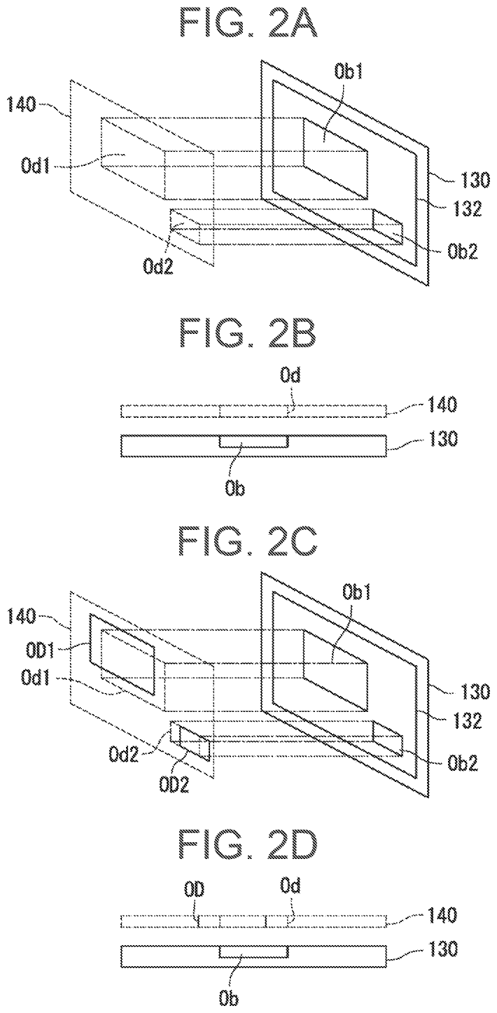

Next, the touch panel device 100 of the present embodiment will be described with reference to FIGS. 1 and 2. First, the touch panel device 100 before correcting the object detection area Od will be described with reference to FIGS. 2A and 2B. FIG. 2A is a schematic perspective view of the touch panel device 100 showing the positional relationship between the object Ob of the display panel 130 and the object detection area Od of the touch sensor 140 before correction. FIG. 2B is a schematic view of the touch panel device 100 showing the positional relationship between the object Ob of the display panel 130 and the object detection area Od of the touch sensor 140 before correction.

As shown in FIGS. 2A and 2B, the display panel 130 displays the objects Ob1 and Ob2 on the display screen 132. The object Ob1 is positioned substantially at the center of the display screen 132, and the object Ob2 is positioned at the lower right of the display screen 132.

The touch sensor 140 has an object detection area Od1 corresponding to the object Ob1. The object detection area Od1 is set at a position corresponding to the position of the object Ob1 on the display panel 130. When the operator performs a touch operation on the object detection area Od1 corresponding to the object Ob1, the display panel 130 is driven according to the operation set to the object Ob1.

The touch sensor 140 has an object detection area Od2 corresponding to the object Ob2. The object detection area Od2 is set at a position corresponding to the position of the object Ob2 on the display panel 130. When the operator performs a touch operation on the object detection area Od2 corresponding to the object Ob2, the display panel 130 is driven according to the operation set to the object Ob2. In the present disclosure, the object detection area Od1 and the object detection area Od2 may be referred to collectively as the object detection area Od.

Thus, the object detection area Od1 is set at a position corresponding to the position of the object Ob1 on the display panel 130, and the object detection area Od2 is set at a position corresponding to the position of the object Ob2 on the display panel 130.

When an operator attempts to operate the position corresponding to the position of the object Ob1 on the display panel 130, the touch sensor 140 may not respond appropriately. This is because the operator does not properly touch the object detection area Od1 of the touch sensor 140.

Similarly, when an operator attempts to operate a position corresponding to the position of the object Ob2 on the display panel 130, the touch sensor 140 may not respond appropriately. This is because the operator does not properly touch the object detection area Od2 of the touch sensor 140.

For example, when the operator operates the object Ob1 of the display panel 130, the operator may tend to operate the upper left portion of the object detection area Od1 of the touch sensor 140 and a portion more upper left than the object detection area Od1. In this case, the touch sensor 140 may react to a position slightly distant from a position corresponding to the object Ob1 of the display panel 130.

When the operator operates the object Ob2 of the display panel 130, the operator may tend to operate the right portion of the object detection area Od2 of the touch sensor 140 and a portion more right than the object detection area Od2. In this case, the touch sensor 140 may react to a position slightly distant from a position corresponding to the object Ob2 of the display panel 130.

Next, the touch panel device 100 after correcting the object detection area Od will be described with reference to FIGS. 2C and 2D. FIG. 2C is a schematic perspective view of the touch panel device 100 showing the positional relationship between the object Ob of the display panel 130 and the object detection area OD after correction of the touch sensor 140, and FIG. 2B is a schematic diagram of the touch panel device 100 showing the positional relationship between the object Ob of the display panel 130 and the object detection area OD after correction of the touch sensor 140.

As shown in FIGS. 2C and 2D, the display panel 130 displays the objects Ob1 and Ob2 on the display screen 132. The object Ob1 is positioned substantially at the center of the display screen 132, and the object Ob2 is positioned at the lower right of the display screen 132.

Here, in the touch sensor 140, the object detection area OD1 for selecting the object Ob1 is set at a position deviated to the upper left side from the original object detection area Od1 corresponding to the object Ob1. The object detection area OD1 is set at a position deviated to the upper left side from the original object detection area Od1 corresponding to the object Ob1 of the display panel 130. When the operator performs a touch operation on any detection point in the object detection area OD1, the display panel 130 is driven according to the operation set to the object Ob1.

In the touch sensor 140, an object detection area OD2 for selecting the object Ob2 is set at a position deviated to the right from an original object detection area Od2 corresponding to the object Ob2. The object detection area OD2 is set at a position deviated to the right from the original object detection area Od2 corresponding to the object Ob2 of the display panel 130. When the operator performs a touch operation on any detection point in the object detection area OD2, the display panel 130 is driven according to the operation set to the object Ob2. In the present disclosure, the object detection area OD1 and the object detection area OD2 may be referred to collectively as the object detection area OD.

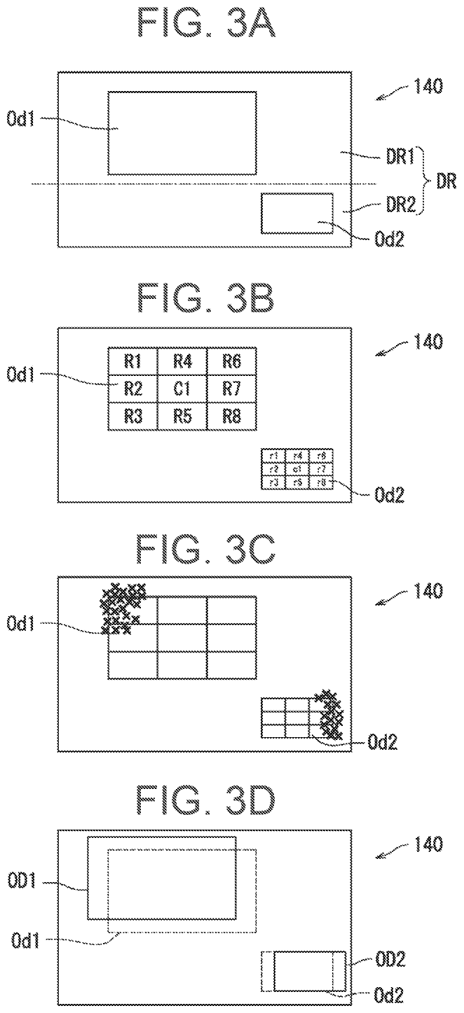

Next, an object detection area Od of the touch sensor 140 in the touch panel device 100 of the present embodiment will be described with reference to FIGS. 1 to 3D. FIG. 3A is a schematic diagram showing an object detection area Od before correction of the touch sensor 140, FIG. 3B is a schematic diagram showing a divided object detection area Od of the touch sensor 140, FIG. 3C is a schematic diagram showing a position where touch operation is performed with respect to the touch sensor 140, and FIG. 3D is a schematic diagram showing the touch panel device 100 in which the object detection area OD is set by correction.

As shown in FIG. 3A, the object detection area Od of the touch sensor 140 has a rectangular shape. Typically, the object detection area Od has a shape corresponding to the object Ob. Here, the object Ob is a rectangular button, and the object detection area Od is rectangular.

The touch sensor 140 has a detection range DR. The detection range DR overlaps at least a part of the display screen of the display panel 130. The detection range DR may overlap the entire display screen of the display panel 130.

The detection range DR of the touch sensor 140 is divided into two areas. The detection range DR is divided into a range DR1 and a range DR2. The range DR1 is located above the detection range DR, and the range DR2 is located below the detection range DR. An object detection area Od1 corresponding to the object Ob1 is positioned in the range DR1. An object detection area Od2 corresponding to the object Ob2 is positioned in the range DR2.

The division range setting unit 114 may divide the detection range DR into the ranges DR1 and DR2 based on the display image including the objects Ob1 and Ob2. For example, the division range setting unit 114 may divide the detection range DR into the range DR1 and the range DR2 based on the difference between the positions of the coordinates in the longitudinal direction of the objects Ob1 and Ob2. Alternatively, the division range setting unit 114 may divide the detection range DR into the ranges DR1 and DR2 based on the difference between the positions of the coordinates in the lateral direction of the objects Ob1 and Ob2.

As shown in FIG. 3B, the object detection area Od1 is divided into a plurality of areas. The division range setting unit 114 divides an object detection area Oc into a plurality of areas.

Here, the object detection area Od1 is divided into nine areas. An object detection area Od1 includes a central area C1, an upper left area R1 positioned on the upper left side with respect to the central area C1, a left area R2 positioned on the left side with respect to the central area C1, a lower left area R3 positioned on the lower left side with respect to the central area C1, an upper area R4 positioned on the upper side with respect to the central area C1, a lower area R5 positioned on the lower side with respect to the central area C1, an upper right area R6 positioned on the upper right side with respect to the central area C1, a right area R7 positioned on the right side with respect to the central area C1, and a lower right area R8 positioned on the lower right side with respect to the central area C1.

Similarly, the object detection area Od2 is divided into nine areas. An object detection area Od2 has a central area cl, an upper left area r1 positioned on the upper left side with respect to the central area cl, a left area r2 positioned on the left side with respect to the central area cl, a lower left area r3 positioned on the lower left side with respect to the central area cl, an upper area r4 positioned on the upper side with respect to the central area cl, a lower area r5 positioned on the lower side with respect to the central area cl, an upper right area r6 positioned on the upper right side with respect to the central area cl, a right area r7 positioned on the right side with respect to the central area cl, and a lower right area r8 positioned on the lower right side with respect to the central area cl.

As shown in FIG. 3C, the touch sensor 140 acquires the position of the touch operation when the objects Ob1 and Ob2 of the display panel 130 are operated. When selecting the object Ob1, an operation position deviation specifying unit 116 specifies how many times the central area C1 of the object detection area Od1, from the upper left area R1 to the lower right area R8, and the area around the object detection area Od1 have been operated. Similarly, when selecting the object Ob2, the operation position deviation specifying unit 116 specifies how many times the central area cl of the object detection area Od2, from the upper left area r1 to the lower right area r8, and the area around the object detection area Od2 have been operated.

In FIG. 3C, the positions touched when the objects Ob1 and Ob2 are operated are indicated by “x”. When the object Ob1 is operated by touch, the operator operates a plurality of times the upper left side of the object detection area Od1 and the upper left side of the object detection area Od1 with respect to the center of the object detection area Od1 of the touch sensor 140. An operation position deviation specifying unit 116 specifies a range corresponding to a touch operation position in the detection range DR as a range DR1, and specifies a deviation between the center of the object Ob1 and the touch operation position. The storage unit 120 stores such an operation position deviation as an operation position deviation of the range DR1.

When the operator operates a plurality of times the object Ob2 of the display panel 130, the operator operates the right portion of the object detection area Od2 and a portion more right than the object detection area Od2 with respect to the center of the object detection area Od2 of the touch sensor 140. An operation position deviation specifying unit 116 specifies a range corresponding to a touch operation position in the detection range DR as a range DR2, and specifies a deviation between the center of the object Ob2 and the touch operation position. The storage unit 120 stores such an operation position deviation as an operation position deviation of the range DR2.

As shown in FIG. 3D, the object detection area Od1 is corrected to the object detection area OD1, and the object detection area Od2 is corrected to the object detection area OD2. The correction unit 118 corrects an original object detection area Od1 corresponding to the object Ob1 to a position deviated to the upper left side as an object detection area OD1 based on the operation position deviation of the range DR1. Therefore, when the operator performs a touch operation on the object detection area OD1, the display panel 130 is driven according to the operation set for the object Ob1.

The correction unit 118 corrects the original object detection area Od2 corresponding to the object Ob2 to a position deviated to the right as the object detection area OD2 based on the operation position deviation of the range DR2. Therefore, when the operator performs a touch operation on the object detection area OD2, the display panel 130 is driven according to the operation set for the object Ob2.

In this manner, the correction unit 118 corrects the object detection area OD to a position deviated from the original object detection area Od corresponding to the object Ob based on the operation position deviation stored for each of the plurality of ranges obtained by dividing the detection range DR. Therefore, the positional deviation of the touch operation can be effectively suppressed.

In FIG. 2A to FIG. 3D, the detection range DR is divided into two ranges DR1 and DR2 in order to avoid unduly complicating the description, but the present embodiment is not limited to this. The detection range DR may be divided into three or more ranges.

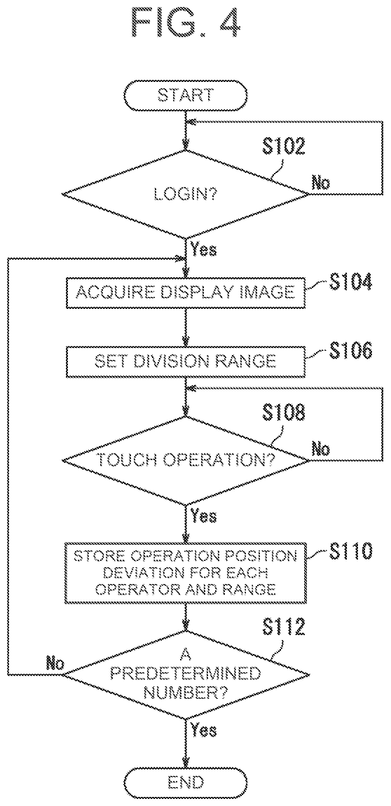

Next, an operation flow of the touch panel device 100 according to the present embodiment will be described with reference to FIGS. 1 to 4. FIG. 4 is a flowchart for acquiring operation position deviation data for correcting the object detection area Od in the touch panel device 100 of the present embodiment.

As shown in FIG. 4, in step S102, it is determined whether or not the operator has logged in. The operator can be identified by determining the login of the operator.

If the operator is not logged in (No in step S102), the process returns to step S102. If the operator logs in (Yes in step S102), the process proceeds to step S104.

In step S104, the panel driving unit 112 acquires the display image. The panel driving unit 112 drives the display panel 130 so that the display panel 130 displays the display image. The panel driving unit 112 may acquire the display image from the storage unit 120. Alternatively, the panel driving unit 112 may acquire the display image from an external device.

In step S106, the division range setting unit 114 divides the detection range DR of the touch sensor 140 into a plurality of ranges. For example, the division range setting unit 114 divides the detection range DR into a plurality of ranges on the basis of the display image. In one example, the division range setting unit 114 divides the detection range DR into a plurality of ranges based on the arrangement of objects in the display image.

In step S108, it is determined whether or not the position detecting unit 142 has detected the touch operation position. If the position detecting unit 142 does not detect the touch operation position (No in step S108), the process returns to step S108 and waits until the position detecting unit 142 detects the touch operation position. If the position detecting unit 142 detects the touch operation position (Yes in step S108), the process proceeds to step S110.

In step S110, the operation position deviation specifying unit 116 specifies a range corresponding to the touch operation position in the detection range DR, and specifies a deviation between the center of the object and the touch operation position. Thereafter, the storage unit 120 stores operation position deviation data indicating the operation position deviation for each operator and each range within the detection range DR.

In step S112, the control unit 110 determines whether or not the number of operation position deviations stored for each operator and each range within the detection range DR exceeds a predetermined number. If the number of operation position deviations does not exceed the predetermined number (No in step S112), the process returns to step S104. If the number of operation position deviations exceeds the predetermined number (Yes in step S112), the process ends. As described above, the operation position deviation data can be obtained.

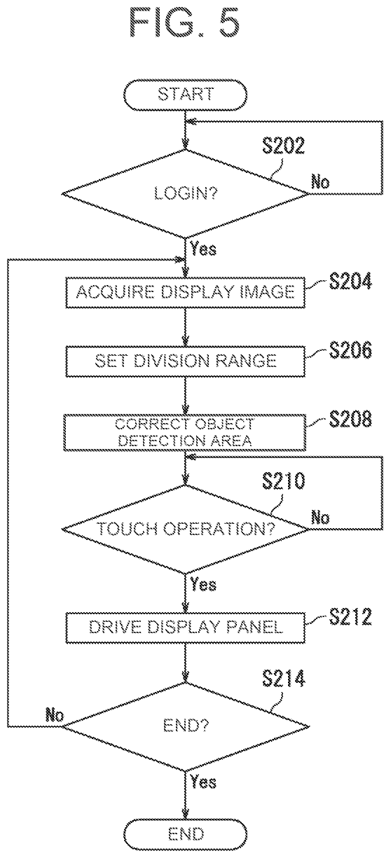

Next, an operation flow of the touch panel device 100 according to the present embodiment will be described with reference to FIGS. 1 to 5. FIG. 5 is a flowchart showing the operation of the touch panel device 100 according to the present embodiment.

As shown in FIG. 5, in step S202, it is determined whether or not the operator has logged in. If the operator is not logged in (No in step S202), the process returns to step S202. If the operator logs in (Yes in step S202), the process proceeds to step S204.

In step S204, the panel driving unit 112 acquires the display image. The panel driving unit 112 drives the display panel 130 so that the display panel 130 displays the display image. The panel driving unit 112 may acquire the display image from the storage unit 120. Alternatively, the panel driving unit 112 may acquire the display image from an external device.

In step S206, the division range setting unit 114 divides the detection range DR of the touch sensor 140 into a plurality of ranges. For example, the division range setting unit 114 divides the detection range DR into a plurality of ranges on the basis of the display image. In one example, the division range setting unit 114 divides the detection range DR into a plurality of ranges based on the arrangement of objects in the display image.

In step S208, the correction unit 118 corrects the object detection area Od based on the operation position deviation stored for each of the operators and the ranges within the detection range DR. The correction unit 118 corrects the object detection area Od based on the operation position deviation data showing the deviation of the operation position stored in the storage unit 120.

In step S210, it is determined whether or not the position detecting unit 142 has detected the touch operation position. If the position detecting unit 142 does not detect the touch operation position (No in step S210), the process returns to step S210. If the position detecting unit 142 detects the touch operation position (Yes in step S210), the process proceeds to step S212.

In step S212, the panel driving unit 112 drives the display panel 130 based on the touch operation position touched on the touch sensor 140 and the corrected object detection area Od. Thereafter, the process proceeds to step S214.

In step S214, it is determined whether or not to end the operation. If the operation is not to be ended (No in step S214), the process returns to step S204. When the operation is to be ended (Yes in step S214), the process is ended.

As described above, the object detection area Od can be corrected based on the operation position deviation data to drive the panel driving unit 112. Therefore, the positional deviation of the touch operation can be effectively suppressed.

In the touch panel device 100 shown in FIGS. 2A to 3D, the detection range DR of the touch sensor 140 is divided into two parts in the longitudinal direction, but the present embodiment is not limited to this. The detection range DR of the touch sensor 140 may be divided laterally. Alternatively, the detection range DR of the touch sensor 140 may be divided longitudinally and laterally.

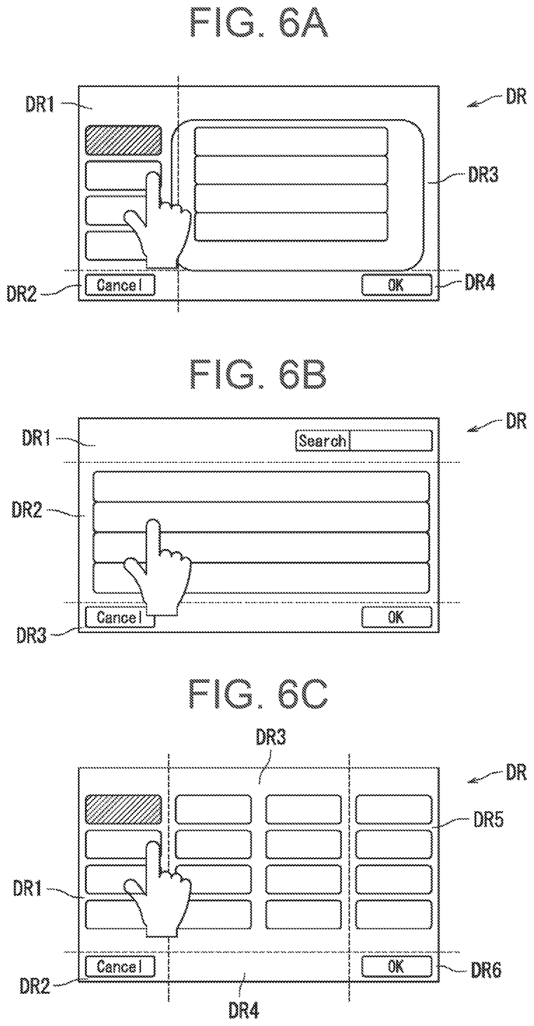

Next, the touch panel device 100 of the present embodiment will be described with reference to FIG. 6. FIGS. 6A to 6C are schematic views of the touch panel device 100 of the present embodiment in which the mode of dividing the detection range DR of the touch sensor 140 is different.

As shown in FIG. 6A, the detection range DR of the touch sensor 140 may be divided into two parts in the lateral direction and two parts in the longitudinal direction. In this case, the division range setting unit 114 divides the detection range DR of the touch sensor 140 into four parts.

Here, the upper left portion of the detection range DR of the touch sensor 140 divided into four parts is described as range DR1, the lower left portion as range DR2, the upper right portion as range DR3, and the lower right portion as range DR4. A selection button is arranged in the range DR1, and a cancel button is arranged in the range DR2. The selection button is arranged in the range DR3, and an OK button is arranged in the range DR4.

The division range setting unit 114 may divide the detection range DR of the touch sensor 140 according to the object of the display image. For example, the division range setting unit 114 divides the detection range DR of the touch sensor 140 into two parts according to the arrangement of the objects along the vertical direction (longitudinal direction) in the display image. Further, the division range setting unit 114 divides the detection range DR of the touch sensor 140 into two parts according to the arrangement of the objects along the right-left direction (lateral direction) in the display image. As a result, the division range setting unit 114 divides the detection range DR of the touch sensor 140 into four parts.

As shown in FIG. 6B, the detection range DR of the touch sensor 140 may be longitudinally divided into three sections without being laterally divided. In this case, the division range setting unit 114 divides the detection range DR of the touch sensor 140 into three parts.

Here, the upper part of the detection range DR of the touch sensor 140 divided into three parts is described as the range DR1, the center part is described as the range DR2, and the lower part is described as the range DR3. A search column is arranged in the range DR1, the selection button is arranged in the range DR2, and a cancel button and an OK button are arranged in the range DR3.

The division range setting unit 114 may divide the detection range DR of the touch sensor 140 according to the object of the display image. For example, the division range setting unit 114 divides the search fields and buttons arranged along the vertical direction (longitudinal direction) in the display image. The division range setting unit 114 divides the buttons arranged along the vertical direction (longitudinal direction) in the display image from the cancel button and the OK button. As a result, the division range setting unit 114 divides the detection range DR of the touch sensor 140 into three parts.

As shown in FIG. 6A, the detection range DR of the touch sensor 140 may be divided into three parts in the lateral direction and two parts in the longitudinal direction. In this case, the division range setting unit 114 divides the detection range DR of the touch sensor 140 into six parts.

Here, the upper left portion of the detection range DR of the touch sensor 140 divided into six sections is described as range DR1, the lower left portion as range DR2, the upper center portion as range DR3, the lower center portion as range DR4, the upper right portion as range DR5, and the lower right portion as range DR6. A selection button is arranged in the range DR1, and a cancel button is arranged in the range DR2. A selection button is arranged in the range DR3, and no object is arranged in the range DR4. A selection button is arranged in the range DR5, and an OK button is arranged in the range DR6.

The division range setting unit 114 may divide the detection range DR of the touch sensor 140 according to the object of the display image. For example, the division range setting unit 114 divides the selection button from the cancel button and the OK button arranged along the vertical direction (longitudinal direction) in the display image into two parts in the longitudinal direction. The division range setting unit 114 divides between the selection button, the cancel button, and the OK button arranged along the right-left direction (lateral direction) in the display image into three parts in the lateral direction. As a result, the division range setting unit 114 divides the detection range DR of the touch sensor 140 into six parts.

The touch panel device 100 of this embodiment is suitably used as a part of an electronic apparatus. For example, the touch panel device 100 may be used as a part of the image forming apparatus.

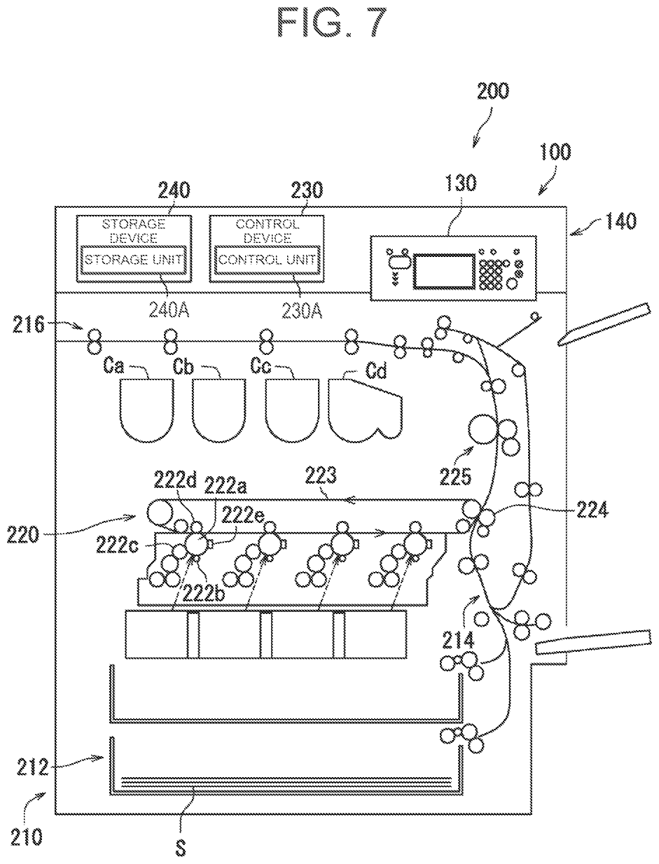

Next, the touch panel device 100 of the present embodiment will be described with reference to FIG. 7. FIG. 7 is a schematic view of an image forming apparatus 200 including the touch panel device 100 according to the present embodiment. Here, the image forming apparatus 200 is an electrophotographic system.

As shown in FIG. 7, in addition to the touch panel device 100, the image forming apparatus 200 includes a conveying unit 210, an image forming unit 220, a control device 230, and a storage device 240. The control device 230 includes a control unit 230A. The control unit 230A controls the conveying unit 210 and the image forming unit 220. The control device 230 can control the touch panel device 100 and the image forming unit 220 in conjunction with each other.

The storage device 240 includes a storage unit 240A. The storage unit 240A stores information used for controlling the control unit 230A.

The conveying unit 210 has a feeding unit 212, a conveying roller 214, and a discharge tray 216.

The feeding unit 212 stores a plurality of sheets S. The sheet S is, for example, a sheet of paper. The feeding unit 212 feeds the sheet S to the conveying roller. The conveying roller conveys the sheet S to the image forming unit 220. The conveying roller includes a plurality of conveying rollers.

The image forming apparatus 200 is loaded with toner containers Ca to Cd. Each of the toner containers Ca to Cd is detachably attached to the image forming apparatus 200. Toners of different colors are stored in respective toner containers Ca to Cd. The toners in the toner containers Ca to Cd are supplied to the image forming unit 220. An image forming unit 220 forms an image by using the toners from the toner containers Ca to Cd.

For example, the toner container Ca stores a yellow toner and supplies the yellow toner to the image forming unit 220. The toner container Cb stores a magenta toner and supplies the magenta toner to the image forming unit 220. The toner container Cc stores a cyan toner and supplies the cyan toner to the image forming unit 220. The toner container Cd stores a black toner and supplies the black toner to the image forming unit 220.

An image forming unit 220 forms an image based on image data on a sheet S by using toner stored in the toner containers Ca to Cd. Here, the image forming unit 220 includes an exposure unit 221, a photoreceptor drum 222a, a charging unit 222b, a developing unit 222c, a primary transfer roller 222d, a cleaning unit 222e, an intermediate transfer belt 223, a secondary transfer roller 224, and a fixing unit 225.

The photoreceptor drum 222a, the charging unit 222b, the developing unit 222c, the primary transfer roller 222d, and the cleaning unit 222e are provided corresponding to the toner containers Ca to Cd, respectively. The plurality of the photoreceptor drums 222a abut on the outer surface of the intermediate transfer belt 223 and are arranged along the rotational direction of the intermediate transfer belt 223. The plurality of primary transfer rollers 222d are provided corresponding to the plurality of photoreceptor drums 222a. The plurality of primary transfer rollers 222d face the plurality of photoreceptor drums 222a via the intermediate transfer belt 223.

The charging unit 222b charges the peripheral surface of the photoreceptor drum 222a. The exposure unit 221 irradiates each of the photoreceptor drums 222a with light based on the image data, and an electrostatic latent image is formed on the peripheral surface of the photoreceptor drum 222a. The developing unit 222c develops the electrostatic latent image by attaching toner to the electrostatic latent image, and forms a toner image on the peripheral surface of the photoreceptor drum 222a. Therefore, the photoreceptor drum 222a carries the toner image. The primary transfer roller 222d transfers the toner image formed on the photoreceptor drum 222a to the outer surface of the intermediate transfer belt 223. The cleaning unit 222e removes toner remaining on the peripheral surface of the photoreceptor drum 222a.

A photoreceptor drum 222a corresponding to the toner container Ca forms a yellow toner image based on the electrostatic latent image, and a photoreceptor drum 222a corresponding to the toner container Cb forms a magenta toner image based on the electrostatic latent image. The photoreceptor drum 222a corresponding to the toner container Cc forms a cyan toner image based on the electrostatic latent image, and the photoreceptor drum 222a corresponding to the toner container Cd forms a black toner image based on the electrostatic latent image.

On the outer surface of the intermediate transfer belt 223, toner images of a plurality of colors are superposed and transferred from the photoreceptor drum 222a to form an image. Therefore, the intermediate transfer belt 223 carries an image. The intermediate transfer belt 223 corresponds to an example of an “image carrier”. The secondary transfer roller 224 transfers the image formed on the outer surface of the intermediate transfer belt 223 to the sheet S. The fixing unit 225 heats and pressurizes the sheet S to fix the image on the sheet S.

The conveying roller conveys the sheet S on which the image is formed by the image forming unit 220 to the discharge tray 216. The discharge tray 216 discharges the sheet S to the outside of the image forming apparatus 200. The discharge tray 216 includes a discharge roller. The sheet S on which the image is printed by the image forming apparatus 200 is discharged from the discharge tray 216 to the outside of the image forming apparatus 200.

The touch panel device 100 receives an input operation from an operator. The touch panel device 100 receives an input operation from an operator by detecting the touch operation of the operator. For example, the touch panel device 100 receives a printing operation from an operator. The touch panel device 100 receives a preview operation from an operator. Alternatively, the touch panel device 100 receives a print decision operation from an operator.

Embodiments of the present disclosure have been described with reference to the drawings. However, the present disclosure is not limited to the above-described embodiments, and can be implemented in various modes without departing from the gist thereof. In addition, various inventions can be formed by appropriately combining a plurality of components disclosed in the above embodiments. For example, some components may be removed from all components shown in the embodiments. In addition, components across different embodiments may be suitably combined. The drawings schematically show the respective components mainly for the purpose of easy understanding, and the thickness, length, number, spacing, etc. of the illustrated components may be different from the actual ones for the convenience of drawing preparation. The materials, shapes, dimensions, etc. of the respective components shown in the above embodiments are only examples, and are not particularly limited, and various changes are possible within a range not substantially deviating from the effects of the present disclosure.

What is claimed is:

1. A touch panel device comprising:
a display panel that displays a display image including an object on a display screen;
a touch sensor that detects a touch operation position touch operated within a detection range with respect to the display screen of the display panel;
a panel driving unit that drives the display panel in accordance with the touch operation position detected by the touch sensor;
a division range setting unit that divides and sets the detection range of the touch sensor into a plurality of ranges;
a correction unit that corrects an object detection area for detecting a touch operation on the object in the touch sensor for each of the plurality of ranges based on operation position deviation data showing an operation position deviation between a position where the object is displayed on the display panel and the touch operation position of the touch sensor for each of the plurality of ranges.

2. The touch panel device according to claim 1, further comprising:
an operator identification unit that identifies an operator; and
a storage unit that stores the operation position deviation data for each operator identified by the operator identification unit.

3. The touch panel device according to claim 1, further comprising an operation position deviation specifying unit that generates the operation position deviation data.

4. The touch panel device according to claim 3, wherein the operation position deviation specifying unit specifies the operation position deviation based on the touch operation position of each of a plurality of areas in the detection range, the plurality of areas resulting by dividing the object detection area.

5. The touch panel device according to claim 1, wherein the division range setting section divides the detection range of the touch sensor in accordance with an arrangement of the object in the display image.

6. The touch panel device of claim 1, wherein the object includes an icon, a button, or a software keyboard.
